(19) United States
(12) Patent Application Publication
(10) Pub. No.: US 2025/0327227 A1
(43) Pub. Date: Oct. 23, 2025

(54) Stitched Preform

(71) Applicant: United States of America as represented by the Administrator of NASA, Washington, DC (US)

(72) Inventors: Erin K. Anderson, Hampton, VA (US); Andrew Elwyn Lovejoy, Hampton, VA (US); Jacob S. Tury, Williamsburg, VA (US)

(21) Appl. No.: 18/760,490

(22) Filed: Jul. 1, 2024

Related U.S. Application Data
(60) Provisional application No. 63/635,656, filed on Apr. 18, 2024.

(51) Int. Cl. D05B 81/00; B32B 5/26; B32B 7/09

(52) U.S. Cl. CPC D05B 81/00; B32B 5/26; B32B 7/09; B32B 2262/16; B32B 2307/516; B32B 2307/52; B32B 2307/7376; D05D 2207/04; D05D 2305/02

(57) ABSTRACT

A sewing system can include a sewing machine; a vacuum pump; and a polymer bag configured to hold a fiber preform and to connect to the vacuum pump so that gas inside the polymer bag is removable by the vacuum pump to thereby reduce a pressure inside the polymer bag to less than an ambient pressure of an outside of the polymer bag, and to compress the fiber preform to a compressed thickness thereby forming a compressed fiber preform, so that a pattern of stitches of a filament are stitchable through the polymer bag and the compressed fiber preform by the sewing machine while the pressure inside the polymer bag is less than the ambient pressure.

### CROSS-REFERENCE TO RELATED PATENT APPLICATION(S)

This patent application claims the benefit of and priority to U.S. Provisional Application No. 63/635,656, filed on Apr. 18, 2024, the contents of which are hereby incorporated by reference in their entirety.

### STATEMENT REGARDING FEDERALLY SPONSORED RESEARCH OR DEVELOPMENT

The invention described herein was made by employees of the United States Government and may be manufactured and used by or for the Government of the United States of America for governmental purposes without the payment of any royalties thereon or therefore.

### BACKGROUND OF THE INVENTION

Composite parts can be manufactured from a reinforcing material and a bulk material and beneficial physical properties of each material can be present in the final composite part. For example, in a fiber reinforced polymer the reinforcing material can include a reinforcing fiber preform and the bulk material can include a polymer resin which can be infused into and encase the reinforcing fiber preform. Such a fiber reinforced polymer can have physical properties attributable to the reinforcing material (e.g., tensile and/or shear strength) and physical properties attributable to the bulk material (e.g., durability, toughness, and/or hardness). Additionally, the interaction of the reinforcing material and bulk material can augment physical properties in component of the composite to improve the physical properties of the composite material beyond what either component material offers.

One aspect of such composite parts which can benefit the aerospace industry is in improved strength-to-weight ratio. Composite parts having sufficient strength at a reduced weight can be substituted for metal part to improve the fuel economy of aircraft (e.g., by reducing the weight of the aircraft).

In making composite parts, the reinforcing material can be provided in a preform which can be shaped by various methods before it is infused and encapsulated with the bulk material. During infusion and encapsulation, the preform can be placed into a bag and the bulk material can be drawn into the bag under vacuum conditions so that the bulk material infuses and encapsulates the preform and achieves a prescribed final shape. The preform can be made from multiple layers of a reinforcing fabric which can have space between the fabric fibers and between the layers and can cause the preform to have dimensions which are larger than the same dimensions after infusion and encapsulation. Before infusion and encapsulation, the preform can be referred to as a “dry preform”. In some shaping processes, the preform is stitched with a reinforcing filament (also referred to as “reinforcing thread”). Such stitching can help to maintain the preform shape during infusion and encapsulation. However, before infusion and encapsulation, where stitches are not present, the preform can be thicker than after infusion and encapsulation.

A sewing machine can be used to sew stitches into a preform before infusion and encapsulation. However, the sewing machine can have a limitation on the thickness of material that can be sewn based on a distance between the needle at the top of a sewing stroke and a work surface on which the preform is held during sewing.

### BRIEF SUMMARY OF THE INVENTION

As disclosed herein a sewing system can include: a sewing machine; a vacuum pump; and a polymer bag configured to hold a fiber preform and to connect to the vacuum pump so that gas inside the polymer bag is removable by the vacuum pump to thereby reduce a pressure inside the polymer bag to less than an ambient pressure of an outside the polymer bag, and to compress the fiber preform to a compressed thickness thereby forming a compressed fiber preform, so that a pattern of stitches of a filament are stitchable through the polymer bag and the compressed fiber preform by the sewing machine while the pressure inside the polymer bag is less than the ambient pressure.

In an implementation, the vacuum pump and polymer bag can be configured so that the pressure inside the polymer bag is less than or equal to about 90% of the ambient pressure.

In an implementation, the system can further include a tool which is insertable into the polymer bag and is configured to support at least a portion of the compressed fiber preform so that a shape of the compressed fiber preform corresponds to a final shape of a composite part made from the compressed fiber preform.

As disclosed herein, a method can include: evacuating a sealed polymer bag containing a fiber preform to an evacuation pressure which is less than an ambient pressure with a vacuum pump to form a compressed fiber preform; and stitching through the sealed polymer bag and the compressed fiber preform with a filament while the sealed polymer bag is evacuated to form a stitched fiber preform.

In an implementation, the sealed polymer bag is sealable by: applying adhesive to edges of a polymer film, and folding the polymer film over the fiber preform and adhering the edges together with the adhesive to seal the edges of the polymer film and thereby form the sealed polymer bag.

In an implementation, the method can further include: sealing, inside the sealed polymer bag, a tool with the fiber preform, wherein the tool is configured to support at least a portion of the fiber preform so that a shape of the portion of the fiber preform when the polymer bag is evacuated corresponds to a final shape of the portion of the fiber preform in a composite part made from the fiber preform.

In an implementation, the evacuating can further include: forming a gas outlet in the sealed polymer bag through which gas is withdrawable through the polymer bag; connecting the vacuum pump to the gas outlet; and operating the vacuum pump to withdraw gas from the sealed polymer bag through the gas outlet.

In an implementation, the method can further include: sealing, in the sealed polymer bag, a material having a void fraction of greater than or equal to about 25% so as to provide an evacuation channel through which gas from inside the sealed polymer bag is evacuated.

In an implementation, the method can further include separating the stitched fiber preform from the sealed polymer bag.

In an implementation, the method can further include infusing and encapsulating the separated stitched fiber preform with a bulk material to form a composite part.

In an implementation, the stitching can further include: fixing at least one of the tool and the fiber preform to a work surface while the stitching is performed.

As disclosed herein, a fiber preform can include: an uncompressed portion having an uncompressed thickness and a compressed portion having a compressed thickness; and a filament extended along the compressed portion in a pattern, through the fiber preform in a thickness dimension, and along a surface of the fiber preform in a length dimension and thereby causing the compressed portion to be compressed, wherein the compressed thickness is less than or equal to about 75% of the uncompressed thickness and the filament exhibits a linear shape through the fiber preform in the thickness dimension.

In an implementation, at least the compressed portion can include a plurality of layered fiber sheets.

In an implementation, two or more fiber sheets of the plurality of layered fiber sheets can each include a plurality of bundles of unidirectional fibers which can be stitched together with crossing filaments extending non-parallel to the plurality of bundles of the unidirectional fibers, and at least two of the two or more fiber sheets can be oriented so that the plurality of bundles of unidirectional fibers are non-parallel.

In an implementation, the plurality of bundles of unidirectional fibers can include uncrimped fibers.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

FIG. 1 is a block diagram of a method as disclosed herein;

FIG. 2 is a fiber preform manufactured by the method of FIG. 1;

FIG. 3 is a schematic illustration of the AA cross-section of the fiber preform of FIG. 2;

FIG. 4 is a schematic illustration of the BB cross-section of the fiber preform of FIG. 2; and

FIG. 5 is a block diagram of a system for performing the method of FIG. 1 in manufacturing of a fiber preform as in FIG. 2.

### DETAILED DESCRIPTION OF THE INVENTION

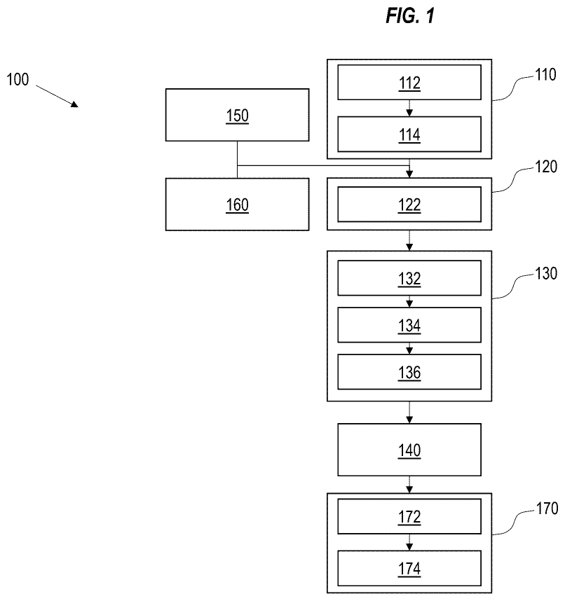

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

As shown in FIG. 1, a method 100 (e.g., a method of manufacturing) can include a first step 110 including placing a fiber preform into a polymer bag, a second step 120 including sealing the polymer bag, a third step 130 including evacuating the polymer bag to an evacuation pressure which is less than an ambient pressure with a vacuum pump so that the fiber preform becomes compressed, and a fourth step 140 including stitching through the polymer bag and the compressed fiber preform with a filament while the polymer bag is evacuated.

The first step 110 can include forming the polymer bag around the fiber preform. For example, the first step 110 can include a first sub-step 112 including laying the fiber preform onto a polymer film, and a second sub-step 114 including applying an adhesive to edges of the polymer film. When the first step 110 includes forming the polymer bag around the fiber preform, the second step 120 can further include a third sub-step 122 including folding the polymer film over the fiber preform and sealing the edges together (e.g., with an adhesive or by bonding the edges together so that the edges are airtight) to thereby form the polymer bag. When the first step 110 does not include forming the polymer bag around the fiber preform, such as when the polymer bag has one open edge through which the fiber preform can be inserted into the polymer bag, the second step 120 can include applying an adhesive to the one open edge and adhering the open edge with the adhesive (e.g., pressing together opposing edges of the polymer bag with adhesive therebetween, curing the adhesive between opposing edges of the polymer bag, and the like) so that the open edge becomes sealed.

The second step 120 can include sealing the polymer bag around the fiber preform. For example, the second step can include inserting the fiber preform into a partially sealed bag and sealing the remaining edges with adhesive or by bonding the edges to one another so that the edges are airtight.

The method 100 can include a step of sealing, inside the polymer bag, a tool with the fiber preform. For example, the method 100 can include a fifth step 150 including placing a tool in the polymer bag with the fiber preform. The tool can be configured to support at least a portion of the fiber preform so that a shape of the at least the portion of the fiber preform when the polymer bag is evacuated corresponds to a final shape of the at least the portion of the fiber preform in a composite part made from the fiber preform. The tool can include a rigid material configured to position at least a portion of the fiber preform into a shape that corresponds to the final shape of the fiber preform once it is infused and encapsulated by the bulk material (e.g., during a subsequent infusion and encapsulation step, such as a vacuum consolidation step). For example, the tool can be configured to occupy space in the polymer bag and/or support the fiber preform so that, when the bag is evacuated and the fiber preform is thereby compressed, the fiber preform will not move out of a position corresponding to a final position of the fiber preform in the composite part. In this way, the tool can help to prevent at least the portion of the fiber preform from sagging, rotating, elongating, curving, raising, bending, and the like during the evacuation process.

The third step 130 can include a fourth sub-step 132, a fifth sub-step 134, and a sixth sub-step 136. The fourth sub-step 132 can include forming a gas outlet in the polymer bag through which gas is withdrawable through the polymer bag. The forming of the gas outlet in the polymer bag can include performing on a portion of a side of the polymer bag a cutting, melting, punching, and/or similar process. In an implementation, the polymer bag can be formed with an opening therethrough which can serve as the gas outlet (e.g., such as with an additive manufacturing process or a forming process in which a section of the bag is not formed to serve as the opening). For example, the fourth sub-step 132 can include inserting a vacuum pump attachment through the polymer bag (e.g., through the gas outlet). A vacuum pump attachment can include a fitting configured to pass a gas therethrough and to couple to a corresponding attachment on a hose of the vacuum pump. A vacuum pump attachment can be configured so that it does not pass through the bag, but instead interacts with a gas outlet formed in the polymer bag to transmit gas from inside the polymer bag to the vacuum pump. In an implementation, the vacuum pump attachment can include a quick disconnect fitting configured to accept a corresponding quick disconnect fitting attached to the hose of the vacuum pump. The vacuum pump attachment can be configured to be sealed to the polymer bag. For example, an adhesive, a gasket (e.g., O-ring, and the like), or the like can be placed between a surface of the vacuum pump attachment and a surface of the polymer bag so as to prevent gas from leaking through an opening in the polymer bag where the vacuum pump attachment is installed.

The fifth sub-step 134 can include connecting the vacuum pump to the vacuum pump attachment. For example, the vacuum pump can include a hose configured to draw gas from a target location into an inlet so as to decrease the pressure at the target location. The hose can include an end termination having a fitting corresponding to the vacuum pump attachment so that the end termination can couple the vacuum pump attachment and seal the coupling to prevent gases leaking into the hose from locations other than the target location.

The sixth sub-step 136 can include operating the vacuum pump to withdraw gas from the polymer bag. With the vacuum pump fluidly coupled to the polymer bag the vacuum pump can be operated to withdraw gas from the polymer bag. In this case, the sixth sub-step 136 may include performing a leak checking operation where the vacuum pump is operated while monitoring the pressure in the polymer bag. One way to verify that the seals are functioning properly, is by monitoring the pressure in the polymer bag while the vacuum pump is connected to the polymer bag and is operating to evacuate gas from the polymer bag. In this case, if the pressure in the polymer bag decreases to a pressure below an ambient pressure and is stable over time without the vacuum pump operating, then it can indicate that there are no gas leaks. Leak locations can also be identified aurally, e.g., by identifying location(s) where a hissing sound of air entering through the seal is heard (e.g., with the human car and/or a sound monitoring device such as a sound pressure level meter). The seal in the identified location(s) can then be adjusted until the hissing sound stops.

The method 100 can include a step of sealing, inside the polymer bag, a breather material. For example, the method 100 can include a sixth step 160 including sealing a breather material inside the polymer bag so as to provide an evacuation channel through which the polymer bag is evacuated. The breather material can be a material having a void fraction of greater than or equal to about 25%, or greater than or equal to about 30%, or greater than or equal to about 40%, or greater than or equal to about 45%, or greater than or equal to about 50%, or greater than or equal to about 55%, or greater than or equal to about 60%, or greater than or equal to about 65%, or greater than or equal to about 70%, or greater than or equal to about 75%, or greater than or equal to about 80%. The void fraction can refer to a percentage of an open volume to a total volume occupied by the material and can also be referred to as a porosity of the material. The breather material can be a rigid material having free volume. The breather material can act as a semi-hollow structure within the polymer bag through which gas in the bag can pass as it is evacuated through the gas outlet to the vacuum pump. For example, the breather material can remain rigid as the polymer bag is evacuated so as to provide a flow path for gas from within the polymer bag to exit through the gas outlet. In this way, the breather material can be placed so as to extend from the gas outlet along a dimension of the fiber preform (e.g., a largest length of the fiber preform) so as to provide a flow area for gases inside the polymer bag which are furthest away from the gas outlet of the polymer bag.

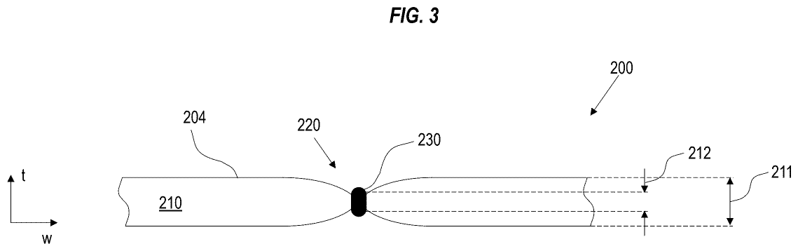

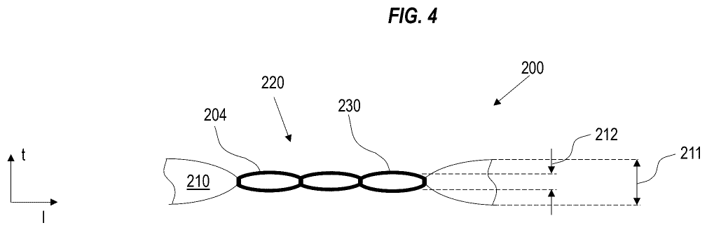

Because the fiber preform includes unoccupied volume (e.g., gas volume) between the fibers of the fiber preform (e.g., and, in the case of a multi-layered preform, between layers), evacuating the gas from the polymer bag will cause the fiber preform to compress as the walls of the polymer bag are sucked inward and contact the fiber preform. In this way, the fiber preform can have an uncompressed thickness 211 (e.g., see FIGS. 3-4) and, when compressed, the compressed fiber preform can have a compressed thickness 212 (e.g., see FIGS. 3-4).

The compression can be a function of a pressure differential between an ambient pressure outside of the polymer bag and a pressure inside the polymer bag. The differential pressure can be set by controlling the vacuum pump. For example, the differential pressure can be set to greater than or equal to about 0.1 atmospheres (atm), or greater than or equal to about 0.2 atm, or greater than or equal to about 0.3 atm, or greater than or equal to about 0.4 atm, or, greater than or equal to about 0.5 atm, or greater than or equal to about 0.6 atm, or greater than or equal to about 0.7 atm, or greater than or equal to about 0.8 atm, or greater than or equal to about 0.9 atm, or equal to about 1 atm.

Once the fiber preform is compressed by evacuating gas from the polymer bag, the fourth step 140 can be performed. The fourth step 140 can include stitching through the polymer bag and the compressed fiber preform with a filament while the polymer bag is evacuated (e.g., while the vacuum pump is running to maintain a vacuum pressure in the bag or after the vacuum pump has run to achieve a vacuum pressure in the bag). Because the polymer bag will be penetrated by the stitching operation (e.g., as the stitching needled extends through the bag and the fiber preform), the vacuum pump can be operated (e.g., intermittently or continuously, and/or with a specific set point for speed, revolutions per minute, pressure inside the polymer bag or hose, or the like) to maintain the pressure inside the polymer bag (e.g., at a pre-determined pressure below the ambient pressure). The stitched filament can help to seal the hole(s) in the polymer bag which is created during the stitching process. However, it can be unlikely that the stiches will completely seal the punctured polymer bag. Therefore, the vacuum pump can be operated (e.g., continually engaged to maintain a set pressure inside the polymer bag) during the stitching operations.

The fourth step 140 can further include fixing at least one of the tool and the fiber preform to a work surface while the stitching is performed. For example, a clamp, fastener, elastic band, tape, or similar device can be used to fix at least one of the tool and the fiber preform (e.g., in the compressed state) to a work surface of a sewing machine. Retaining the tool and/or fiber preform in this way can help to prevent and/or reduce movement of the fiber preform during the stitching operation and can help to achieve manufacturing of parts consistent with minimal dimensional tolerances.

The aforementioned methods can be performed in a manual way, such as by one or more workers performing the steps of the method. Alternatively, the aforementioned methods can be performed in an automated manner, such as by one or more robots configured to perform the steps of the method, or semi-automated manner, such as by one or more robots configured to perform the steps of the method, or portions thereof. with the remaining portions being performed by one or more workers. Accordingly, a controller can be configured to cause to be performed, by one or more robots and/or one or more worker, each aforementioned step of the method. For example, a controller can be configured to cause the sealing of the polymer bag around the fiber preform; the evacuating the polymer bag to an evacuation pressure which is less than an ambient pressure with the vacuum pump so that the fiber preform becomes compressed; and the stitching through the polymer bag and the compressed fiber preform with the filament while the polymer bag is evacuated.

One unexpected result of the methods disclosed herein include that the inventors found that in the compressed state, a shape of the fiber preform can correspond to a final shape of the fiber preform when it is in a composite part made by a vacuum infusion and encapsulation method (e.g., also referred to as when the part is “consolidated”). In this way, by pre-compressing the fiber preform before and/or during the stitching process the length of the filament stitches extending through the compressed fiber preform can correspond to a length of the filament stitches in the final composite part. Accordingly, the stitched fiber preform as disclosed herein can exhibit a reduced tendency for the filaments to move between the fiber preform stitching operation(s) and the consolidation operations which can result in improved controllability of the filament placement, filament tension, and resultant physical properties (e.g., resistance to through thickness crack propagation) of the final composite part in comparison to other stitching methods.

In contrast, other methods of stitching the fiber preform, such as stitching the fiber preform without vacuum compression as described herein, can result in longer stitch lengths or stitches having higher than desired tension. Longer stitch lengths can result when the length of filament needed to extend through the uncompressed fiber preform is greater than the length of filament needed to extend through the compressed fiber preform. Accordingly, when the fiber preform is stitched in an uncompressed state then consolidated, the stitches can loosen and/or take on a non-linear shape in the thickness dimension of the consolidated composite part. For example, within the fiber preform the stitches can exhibit a wavy, wiggle, or zig-zag type shape in the thickness dimension to take up some of the extra filament length, or outside the fiber preform, filament at the top and/or bottom of a stitch can be longer and looser than necessary and exhibit a wavy, wiggle, or zig-zag type shape. This can lead to the final composite part having lower strength, lower ability to absorb impact, higher likelihood of cracking and/or delaminating, and/or other defects that can reduce the performance of the composite material in comparison the methods disclosed herein. Whereas, when the fiber preform is stitched in the compressed state then consolidated, the stitches can retain their shape (e.g., a linear shape) in the thickness dimension of the consolidated composite part.

The evacuation of the sealed polymer bag containing a fiber preform can be temporary. For example, operation of the vacuum pump to evacuate the sealed polymer bag containing the fiber preform can be performed only during the stitching operation(s), setup of the sealed polymer bag in the sewing machine prior to stitching, removal of the sealed polymer bag from the sewing machine following stitching, relative movement between the sealed polymer bag and the sewing machine between stitching operations, or a combination including at least one of the foregoing. In an implementation, evacuation of the sealed polymer bag containing the fiber preform can start following the sealing of the polymer bag (with the fiber preform inside) and end once the stitching of the fiber preform is completed and the stitched fiber preform is removed from the sewing machine.

The method of 100 can include a step of consolidating the fiber preform with a bulk material to form a composite part. For example, the method 100 can include a seventh step 170 including infusing and encapsulating the fiber preform (e.g., while compressed in a vacuum environment) with a bulk material to form a composite part. The seventh step 170 can include a seventh sub-step 172 and an eighth sub-step 174.

The seventh sub-step 172 can include separating the stitched fiber preform from the polymer bag. The polymer bag can be removed from the fiber preform by any suitable method which preserves the integrity of the fiber preform. For example, the polymer bag can be torn and the fiber preform removed. In an implementation, the polymer bag can be torn along perforations caused by the stitching of filament through the polymer bag. In this case, there can remain small pieces of the polymer bag held on the surface of the fiber preform under stitches of the filament. Accordingly, tweezers or other instruments can be used to remove any remaining fragments of the polymer bag before a consolidation process is performed.

The eighth sub-step 174 can include infusing and encapsulating the separated fiber preform with a bulk material to form a composite part. For example, the infusion and encapsulation process (also referred to as consolidation) can include placing the stitched fiber preform into a vacuum bag, attaching a vacuum pump to the vacuum bag to evacuate the bag and flowing a bulk material into the bag while the vacuum bag is kept at a sub-ambient pressure. The bulk material can be a polymer resin or a ceramic material. The consolidation process can further include a curing process (e.g., in the case of a polymer resin bulk material) or hardening process (e.g., in the case of a ceramic bulk material). For example, a curing process can include heating, pressuring, and/or exposing the infused and encapsulated compressed fiber preform to ultraviolet light. A hardening process can include heating and/or pressuring (e.g., to a sintering temperature and/or pressure) the infused and encapsulated compressed fiber preform (e.g., such as in a furnace).

Once consolidation is complete a finished composite part can be obtained. The finished composite part can have the shape of the compressed fiber preform which has been infused and encapsulated with the bulk material.

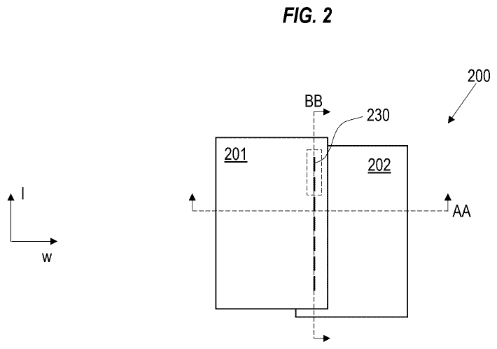

As shown in FIG. 2, the fiber preform 200 can be stitched with a filament 230 in a pattern. Although the pattern shown in FIG. 2 has a linear shape, the pattern can have any shape. The filament 230 can be stitched through the fiber preform 200 in order to couple together separate sections (e.g., separate overlaid sheets). For example, as shown in FIG. 2 a first fiber preform 201 and a second fiber preform 202 are coupled together with the filament 230 stitched through both the first fiber preform 201 and the second fiber preform 202 in a linear pattern.

As shown in FIG. 3 and FIG. 4, which are cross-sectional views along the AA section and BB section of FIG. 2 respectively, the fiber preform 200 can have an uncompressed portion 210, a compressed portion 220, and the filament 230 stitched along the compressed portion 220. The uncompressed portion 210 can have an uncompressed thickness 211. The compressed portion 220 can have a compressed thickness 212. The filament 230 can extend through the fiber preform 200 in a thickness dimension (along the t-dimension in the Figures), and along a surface 204 of the fiber preform 200 in a length dimension (along the 1-dimension in the Figures) and can cause the compressed portion 220 to be compressed.

The compressed thickness 212 can be less than or equal to the uncompressed thickness 211. The compressed thickness 212 can be a function the polymer bag pressure. For example, increasing the differential pressure between inside the polymer bag and the ambient pressure can result in reducing the compressed thickness 212. This can continue until the fiber preform is no longer compressible (e.g., when there is no more free volume in the fiber preform). The compressed thickness 212 can be less than or equal to about 90%, or less than or equal to about 85%, or less than or equal to about 80%, or less than or equal to about 75%, or less than or equal to about 70%, or less than or equal to about 65%, or less than or equal to about 60%, or less than or equal to about 55%, or less than or equal to about 50% of the uncompressed thickness 211. In an implementation, the compressed thickness 212 can be between about 55% and 75%, or about 66%, of the uncompressed thickness 211. In an implementation, the compressed thickness 212 can be within a range of plus/minus about 20%, within a range of plus/minus about 15%, within a range of plus/minus about 10%, within a range of plus/minus about 5%, within a range of plus/minus about 2% of the thickness of the fiber preform in the final composite part made from the fiber preform (e.g., after a consolidation process is performed on the fiber preform).

The filament 230 can exhibit a linear shape through the fiber preform 200 in the thickness dimension (e.g., in the t-dimension in the Figures). When the fiber preform 200 is stitched in the compressed condition, this linear shape can be maintained during a subsequent consolidation process because the fiber preform 200 was stitched in the compressed condition that the fiber preform 200 will experience during the subsequent consolidation.

The fiber preform 200 can include a plurality of layered fiber sheets. The plurality of layered fiber sheets can be stacked on top of one another to form the uncompressed thickness 211 of the fiber preform 200. The fiber sheets can include bundles of unidirectional fibers which can be stitched together with crossing filaments. The unidirectional fibers can be uncrimped fibers. Two or more fiber sheets of the plurality of layered fiber sheets can be oriented so that the unidirectional fibers are non-parallel to one another. For example, the layered sheets can be oriented to have an angle between the unidirectional, uncrimped fibers of about 5° or more, or about 10° or more, or about 15° or more, or about 20° or more, or about 25° or more, or about 30° or more, or about 35° or more, or about 40° or more, or about 45° or more, or about 50° or more, or about 55° or more, or about 60° or more, or about 65° or more, or about 70° or more, or about 75° or more, or about 80° or more, or about 85° or more, or about 90°. Two or more fiber sheets of the plurality of layered fiber sheets can be oriented so that the unidirectional fibers are parallel.

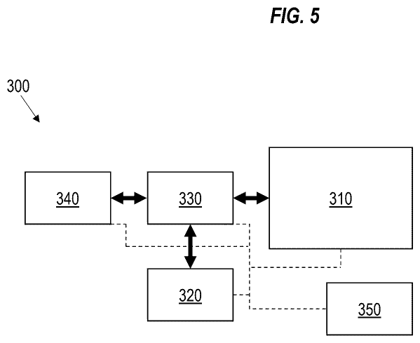

As shown in FIG. 5, a system 300 for performing the methods disclosed herein can include a sewing machine 310, a vacuum pump 320, and a polymer bag 330, and an optional tool 340. The sewing machine 310, a vacuum pump 320, and a polymer bag 330, and the optional tool 340 can be configured to interact with one another (e.g., as indicated by the double-sided arrows in FIG. 5). The polymer bag 330 can be configured to hold a fiber preform 200 (e.g., in an uncompressed state) and to connect to the vacuum pump 320. When connected to the polymer bag 330, the vacuum pump 320 can be operated so that gas inside the polymer bag 330 is removed by the vacuum pump 320 and a pressure inside the polymer bag 330 can be reduced to less than an ambient pressure of outside the polymer bag. By evacuating the polymer bag 330, as described in the foregoing, the fiber preform 200 can be compressed to a compressed thickness 212 to thereby form a compressed fiber preform. While in the compressed state, a pattern of stitches of a filament 230 can be stitched through the polymer bag 330 and the fiber preform 200 (e.g., while in the compressed state) by the sewing machine 310 while the pressure inside the polymer bag 330 is less than the ambient pressure (e.g., so as to maintain the fiber preform 200 in the compressed state).

The vacuum pump 320 and polymer bag 330 can be operably connected and configured so that the vacuum pump 320 can reduce the pressure inside the polymer bag 330 to less than the ambient pressure (e.g., outside the polymer bag 330) as described in the foregoing. For example, the vacuum pump 320 can be configured to operate to reduce the pressure inside the polymer bag 330 to less than or equal to about 90%, or less than or equal to about 85% or less than or equal to about 80%, or less than or equal to about 75%, or less than or equal to about 70%, or less than or equal to about 65%, or less than or equal to about 60%, or less than or equal to about 55%, or less than or equal to about 50% (e.g., less than or equal to about-0.5 atm (gauge) which is also about-0.5 atm (differential)) of the ambient pressure. The vacuum pump 320 can be configured to maintain the pressure inside the bag by operating so as to maintain a predetermined pressure (e.g., in the bag and/or in the hose), revolutions per minute (rpm) of the vacuum pump motor, flow rate (e.g., of gas through the hose), motor speed, or the like. In this way, the vacuum pump 320 can be configured to operate continuously, or intermittently, while the sewing machine 310 stitches the filament 230 through the polymer bag 330 and the fiber preform 200. To accommodate a change in integrity of the polymer bag 330 as it is being stitched, the vacuum pump 320 can operate more frequently, with a higher rpm, with a higher flow rate, and/or with greater speed, to maintain the pressure inside the polymer bag 330 when the number of stiches or the size of stitches through the polymer bag 330 increases.

The system 300 can include an optional tool 340 which can be inserted into the polymer bag 330 as described in the foregoing. The optional tool 340 can be configured to support at least a portion of the fiber preform 200 (e.g., in the compressed state) so that a shape of the compressed fiber preform corresponds to a final shape of a composite part made from the compressed fiber preform.

The polymer bag 330 can be made of any suitable material. The material of the polymer bag 330 can be selected to prevent tearing of the polymer bag 330 when the polymer bag 330 is under a vacuum condition and it is punctured with a sewing needle. Additionally, the material of the polymer bag 330 can be selected so that after sewing is complete, the polymer bag 330 can be easily removed from the sewn fiber preform (e.g., so that the material does rip apart based on the perforations made by the needle during sewing). The material selected for the polymer bag 330 can be chosen based on resistance to tearing while being stitched, while assisting in bag removal by easily tearing along the stitch line during removal (as previously described).

The system 300 can further include a controller 350. The controller can be configured to interact (e.g., as indicated by the dashed lines in FIG. 5) with the sewing machine 310, the vacuum pump 320, the polymer bag 330 and or the optional tool 340 to perform an automated process. For example, the controller 350 can control a robot (e.g., can directly operate a robot or communicate to the robot a command to perform a predetermined action) to place the fiber preform into the polymer bag 330 (e.g., or form and/or seal the polymer bag around the fiber preform).

Optionally, the controller 350 can control a robot to seal, into the polymer bag, a tool (as previously described) with the fiber preform. The tool can be configured to communicate with the controller 350 to indicate that the tool has been sealed in the polymer bag. For example, the tool can include a pressure sensor which can transmit to the controller the pressure that the tool is experiencing, or the tool can include a location or proximity sensor that can be configured to transmit to the controller 350 the location and/or relative position of the tool.

Once the fiber preform is sealed in the polymer bag (e.g., with or without an optional tool), the controller 350 can control a robot (e.g., can directly operate the robot or communicate to the robot a command to perform a predetermined action) to connect the vacuum pump 320 to the polymer bag and control the vacuum pump (e.g., can directly operate the robot or communicate to the robot a command to perform a predetermined action) to evacuate the polymer bag.

Once the polymer bag is evacuated to a predetermined pressure (e.g., communicated from the polymer bag having a pressure transmitter configured to measure the internal pressure of the polymer bag) thereby compressing the fiber preform inside the polymer bag, the controller 350 can control the sewing machine 310 (e.g., can directly operate the sewing machine 310 or communicate to the sewing machine 310 a command to perform a predetermined stitching sequence) to perform a stitching operation to stitch the filament through the polymer bag 330 and the compressed fiber preform. Once the stitching operation is completed (e.g., such as after sewing machine 310 has completed a stitching program (e.g., communicated by the controller 350 or pre-loaded into the sewing machine 310)) the controller 350 can control a robot (e.g., can directly operate the robot or communicate to the robot a command to perform a predetermined action) to remove the stitched fiber preform from the polymer bag.

Once the stitched preform is removed from the polymer bag, the controller 350 can be configured to have the stitched preform infused and consolidated (e.g., in a vacuum consolidation process), such as by controlling a robot (e.g., directly operating a robot or communicating to the robot a command to perform a predetermined action) to seal the stitched preform into a tool for the vacuum consolidation process, to infuse a bulk material into the stitched fiber preform under vacuum conditions so as to form a consolidated composite part. As illustrated in the forgoing, the controller can interact with elements of the system to perform the foregoing method in an automated manner.

As used herein, each of the phrases such as “A or B,” “at least one of A and B,” “at least one of A or B,” “A, B or C,”, A, B, and C″, “at least one of A, B, and C,” and “at least one of A, B, or C” may include any one of the listed items, or all possible combinations thereof. For example, use of “at least one of” preceding a group of items should be interpreted in a disjunctive way with respect to the group of items, e.g., so that presence of one item of the group meets the meaning of the recitation.

As used herein, the words “a,” “an” and “the” are intended to include plural forms of elements unless specifically referenced as a single element.

As used herein, the term “and/or” includes a combination of a plurality of related listed components, or any component among the plurality of related listed components.

As used herein, terms such as “first,” “second,” or “first” or “second” may be used simply to distinguish one component from other components, and do not limit the components in other aspects (e.g., importance or order).

As used herein, the terms “comprise(ing)”, “include(ing)” or “have(ing)” are intended to indicate the presence of a characteristic, number, step, operation, process, component, part, feature, function, and/or element, or any combination thereof described in the present document, and the possibility of the presence or addition of one or more other characteristics, numbers, steps, operations, processes, components, parts, features, functions, and/or elements, or any combination thereof is not precluded.

As used herein, when a component is “connected,” “coupled,” “supported,” or “in contact” with another component, this includes not only cases in which components are directly connected, coupled, supported, or in contact with each other, but also cases in which they are indirectly connected, coupled, supported, or in contact through a third component.

As used herein, when a component is disposed “on” another component, this includes not only a case in which the component is in contact with another component, but also a case in which still another member is present between the two components.

As used herein, a term, such as “about” or “substantially,” is used at a corresponding numerical value or used as a meaning close to the numerical value when e.g., manufacturing and material tolerances which may be inherent in the stated meaning are presented. In particular, as used herein, the terms “about” and “approximately” refer to values that are plus or minus ten percent of the base value. That is, for example, reference to “about 100” or “approximately 100” refers to “90-110” inclusive. In some implementations, “about” may refer to plus or minus five percent of the base value, or plus or minus two percent of the base value.

What is claimed is:

1. A sewing system comprising:
a sewing machine;
a vacuum pump; and
a polymer bag configured to hold a fiber preform and to connect to the vacuum pump so that gas inside the polymer bag is removable by the vacuum pump to thereby reduce a pressure inside the polymer bag to less than an ambient pressure of an outside of the polymer bag, and to compress the fiber preform to a compressed thickness thereby forming a compressed fiber preform, so that a pattern of stitches of a filament are stitchable through the polymer bag and the compressed fiber preform by the sewing machine while pressure inside the polymer bag is less than ambient pressure.

2. The sewing system of claim 1, wherein the vacuum pump and polymer bag are configured so that the pressure inside the polymer bag is less than or equal to about 90% of ambient pressure.

3. The sewing system of claim 1, further comprising a tool which is insertable into the polymer bag and is configured to support at least a portion of the compressed fiber preform so that a shape of the compressed fiber preform corresponds to a final shape of a composite part made from the compressed fiber preform.

4. A method comprising:
evacuating a sealed polymer bag containing a fiber preform to an evacuation pressure which is less than an ambient pressure with a vacuum pump to form a compressed fiber preform; and
stitching through the sealed polymer bag and the compressed fiber preform with a filament while the sealed polymer bag is evacuated to form a stitched fiber preform.

5. The method of claim 4, wherein
the sealed polymer bag is sealable by:
applying adhesive to edges of a polymer film, and
folding the polymer film over the fiber preform and adhering the edges together with the adhesive to seal the edges of the polymer film and thereby form the sealed polymer bag.

6. The method of claim 4, further comprising:
sealing, inside the sealed polymer bag, a tool with the fiber preform,
wherein the tool is configured to support at least a portion of the fiber preform so that a shape of the portion of the fiber preform when the sealed polymer bag is evacuated corresponds to a final shape of the portion of the fiber preform in a composite part made from the fiber preform.

7. The method of claim 4, wherein
the evacuating further includes:
forming a gas outlet in the sealed polymer bag through which gas is withdrawable through the sealed polymer bag;
connecting the vacuum pump to the gas outlet; and
operating the vacuum pump to withdraw gas from the sealed polymer bag through the gas outlet.

8. The method of claim 4, further comprising:
sealing, inside the sealed polymer bag, a material having a void fraction of greater than or equal to about 25% so as to provide an evacuation channel through which gas from inside the sealed polymer bag is evacuated.

9. The method of claim 4, further comprising separating the stitched fiber preform from the sealed polymer bag.

10. The method of claim 9, further comprising infusing and encapsulating the separated stitched fiber preform with a bulk material to form a composite part.

11. The method of claim 6, wherein the stitching further includes fixing at least one of the tool and the fiber preform to a work surface while the stitching is performed.

12. A fiber preform comprising:
an uncompressed portion having an uncompressed thickness and a compressed portion having a compressed thickness; and
a filament extended along the compressed portion in a pattern, through the fiber preform in a thickness dimension, and along a surface of the fiber preform in a length dimension and thereby causing the compressed portion to be compressed,
wherein the compressed thickness is less than or equal to about 75% of the uncompressed thickness and the filament exhibits a linear shape through the fiber preform in the thickness dimension.

13. The fiber preform of claim 12, wherein at least the compressed portion includes a plurality of layered fiber sheets.

14. The fiber preform of claim 13, wherein
two or more fiber sheets of the plurality of layered fiber sheets each include a plurality of bundles of unidirectional fibers which are stitched together with crossing filaments extending non-parallel to the plurality of bundles of the unidirectional fibers, and
at least two of the two or more fiber sheets are oriented so that the plurality of bundles of unidirectional fibers are non-parallel.

15. The fiber preform of claim 14, wherein the plurality of bundles of unidirectional fibers include uncrimped fibers.
